(19) United States
(12) Patent Application Publication
(10) Pub. No.: US 2015/0336172 A1
(43) Pub. Date: Nov. 26, 2015

(54) A METHOD OF PRODUCING A METALLIC BODY PROVIDED WITH A METALLIC CLADDING

(71) Applicant: SANDVIK INTELLECTUAL PROPERTY AB, Sandviken (SE)

(72) Inventor: Erik SALOMONSSON, Kungsor (SE)

(21) Appl. No.: 14/410,176

(22) PCT Filed: Jun. 19, 2013
(86) PCT No.: PCT/EP2013/062789

§ 371 Date: Dec. 22, 2014

(30) Foreign Application Priority Data
Jun. 25, 2012 (EP) 12173411.5

(51) Int. Cl. B22F 7/08; F02M 61/18; B22F 5/10; B22F 3/02; B22F 3/24

(52) U.S. Cl. CPC B22F 7/08; B22F 3/02; B22F 3/24; B22F 5/10; F02M 61/18; B22F 2003/245

(57) ABSTRACT

A method of producing a metallic body provided with a metallic cladding includes the steps of providing a hollow body including a bottom wall and a lateral wall that presents an inner space, filling the space with a metallic cladding material that will form the cladding, positioning the hollow body in a metallic capsule, closing the metallic capsule and evacuating air from the interior of the latter, and applying an elevated pressure and an elevated temperature on the outside of the capsule, such that the cladding material is bonded to the hollow body. The capsule is coaxial with the hollow body and has a lateral inner periphery that has a shape and dimension that corresponds to the shape and dimension of the outer lateral periphery of the hollow body. The hollow body with the core therein is formed in a machining operation in which material is removed from a blank of a solid piece of metal material.

### TECHNICAL FIELD

The present invention relates to a method of producing a metallic body provided with a metallic cladding, comprising the following steps: providing a hollow body that comprises a bottom wall, a core that extends from the bottom wall and a lateral wall and that presents an inner space; filling said space with a metallic cladding material that will form said cladding; positioning the hollow body in a metallic capsule; closing the metallic capsule and evacuating air from the interior of the latter, and; applying an elevated pressure and an elevated temperature on the outside of said capsule such that said cladding material is bonded to said hollow body.

Preferably, but not necessarily, after said application of elevated pressure and elevated temperature, a final body formed by the hollow body and the cladding material is subjected to a machining operation, in which one part thereof is removed and the cladding material is exposed as a cladding on a second part thereof.

The applied elevated pressure is an isostatic pressure generated by means of pressurised gas. The elevated temperature is below the temperatures at which any of the metals used melt. The process of applying elevated pressure and elevated temperature thereby belongs to the processes commonly named Hot Isostatic Pressure processes.

The invention has been developed with regard to the production of injector nozzles for diesel engines, in which there is provided a Ni-base cladding on a tool steel body. However, it should be understood that, even though this is a preferred implementation of the inventive idea, the invention is applicable to production of all kind of metallic bodies in accordance with the preamble of claim 1 in which a metallic cladding material is to be applied on a particular body of another metallic material. The capsule is used for sealing purposes necessary for the HIP process, whereby sealing of each of a large number of the above-mentioned hollow bodies housed in said capsule can be avoided.

### BACKGROUND OF THE INVENTION

Injector needles for diesel engines are presently being produced by means of a method know as the Sand-HIP-Method. According to this method, hollow bodies made of a suitable steel grade and having a central core extending therein are filled with a metallic cladding material formed by a powder, typically a Ni-based powder. Thereby, the exposed part of the central core is totally covered by the powder. The powder is pre-pressed (preferably mechanically) in order to achieve a high density before an elevated pressure and temperature in accordance with the HIP process is later applied thereto. After pre-pressing of the powder, an open top part of the hollow body, through which the powder has been introduced, is closed, and remaining air is evacuated from the interior of the closed hollow body. In this way a plurality of hollow bodies are provided.

Furthermore, there is provided a capsule, in which a plurality of such hollow bodies is to be positioned during the subsequent HIP process. The reason for providing said capsule is that the individual hollow bodies are not sealed and evacuated with regard to air. Said capsule may have a cylindrical or tubular shape with a bottom wall and a lateral wall. The bottom wall is covered with sand, on which said plurality of hollow bodies are positioned side by side in a given pattern with spacing between each hollow body. After that, said spacing is filled with sand. The hollow bodies are also covered with sand on top thereof. Subsequently to the sand-filling operation, the top of the capsule is closed by provision of an upper wall, air is evacuated from the interior of the capsule (and thereby also the interior of the hollow bodies) and the capsule is finally sealed. Thereafter, the capsule is subjected to an elevated pressure and an elevated temperature in accordance with the principles of Hot Isostatic Pressing, whereby the powder of the metallic cladding material densifies further and gets bonded to the surrounding material of the hollow body, including said core. The capsule is then opened and the hollow bodies are taken out. Each (initially) hollow body is machined such that the lateral wall and the top wall are removed and the cladding material is exposed. Also the cladding is machined to such a degree that, outgoing from the given size and extension of the core, a predetermined cladding thickness is achieved on the latter. The machining is a turning operation and is based on the presumption that the geometry of the hollow body is symmetric around a central axis of the latter.

However, during the HIP process, the shape of the hollow body and the core may be somewhat deformed due to the interaction between the sand and the hollow bodies. It is believed that this deformation is due to the fact that friction within the sand results in a non-uniform pressure being applied on the hollow body. As a result of this slight deformation, the extension of the core is not exactly the same as it was initially, resulting in inexactness and an uncertainty of the actual cladding thickness as the material of the hollow body and part of the cladding material is later removed by way of machining. As long as the tolerance requirements are not too tough, this deviation from perfect symmetry can be accepted. However, as tolerance requirements are getting stricter, a way of improving the tolerances upon production of the injection nozzles is requested.

WO20047030850 describes a method for manufacturing fuel nozzles for diesel engines by applying a corrosion resistant cladding onto a preformed core member. Page 16, lines 12-30 and FIG. 3 describes an embodiment for manufacturing of a nozzle by providing a preformed core member 12, placing the core member 12 in a tubular capsule 15, placing a filler pipe 21 around the core member 12 and filling the space between core member and filler pipe with a powder of a cladding material. The arrangement is thereafter subjected to HIP.

U.S. Pat. No. 6,168,871 B1 shows a method of manufacturing blades or vanes for gas turbines. According to one embodiment a vane is manufactured by arranging a jacket 14 around a mandrel 12 and filling the cavity 18 there between with powder. Subsequently, the jacket 12 and/or the mandrel 18 are removed (col 3, line 65-col 4, line 1 and lines 21-24. According to a second embodiment the mandrel 12 may be provided with a cross-sectional configuration to form spars 26 in the interior of the blade (col 4, line 41-51).

A further method for manufacturing a fuel injection nozzle is described in EP2450557.

### THE OBJECT OF THE INVENTION

It is an object of the present invention to present a method of producing a metallic body provided with a metallic cladding which remedies at least some of the above-mentioned deficiencies of prior art.

In particular, it is an object to improve the exactness of the thickness of the cladding, and thereby to enable higher tolerance requirements.

### SUMMARY OF THE INVENTION

The object of the invention is achieved by means of the initially defined method, wherein said capsule is coaxial with the hollow body and has a lateral inner periphery that has a shape and dimension that corresponds to the shape and dimension of the outer lateral periphery of said hollow body, characterised in that said hollow body with the core therein is formed in a machining operation in which material is removed from a blank of a solid piece of material, wherein after said application of elevated pressure and elevated temperature, a final body comprised by the hollow body and the cladding material attached thereto is subjected to a machining operation, in which one first part of said hollow body is removed and the cladding material is exposed as a cladding on a second part of said hollow body wherein said first part comprises the lateral wall of the hollow body and said second part of the hollow body comprises the core that extends from the bottom wall of the hollow body.

Since the hollow body is formed in a machining operation in which material is removed from a blank of a solid piece of the positions of the respective parts of the hollow body, i.e. the core and the hollow wall, are very precise in relation to each other. This in turn provides the advantage that the final body that results after HIP is very symmetric and can be machined such that a high degree of dimensional accuracy of the metallic cladding is achieved.

There is a tight fit, i.e. only a small spacing, between the outer periphery of the hollow body and the inner periphery of the capsule. If said spacing is too large, the capsule may be unevenly (non-uniformly) deformed, and as a result thereof, the pressure applied to the hollow body may non-uniform, and, as result thereof, the hollow body may become deformed, which will affect the exactness of the thickness of the cladding negatively as the latter is exposed by means of a machining operation such as a turning operation.

It is therefore preferred that, at least for the case in which the hollow body has a circular outer periphery, the ratio between an inner diameter (or cross-section measure, for geometries other than circular) of the capsule and an outer diameter (corresponding cross-section measure) of said hollow body, defined as D_{capsule}/D_{hollow body} is in the range of 1-1.15, or even more restricted, preferably in the range of 1-1.10, or even 1-1.05.

According to a preferred embodiment of the invention, the capsule is elongated and has a length which is a plurality of the length of the hollow body, wherein the method includes that a plurality of hollow bodies are stapled on each other inside the capsule before the latter is closed. Thereby, efficient production of large numbers of the coated body is promoted.

According to a preferred embodiment, said first part comprises the lateral wall of the hollow body and said second part of the hollow body comprises a core that extends from the bottom wall of the hollow body, wherein there is a spacing between the lateral outer periphery of said core and the inner periphery of the lateral wall of hollow body, and wherein said spacing is filled with said metallic cladding material. Typically, the hollow body, with the core therein, is produced by a machining operation in which material is removed from a solid piece of metal material, such as a rod or bar, such that the core is exposed and a tubular shape of the body is generated. Thus, preferably, the hollow body is a tubular body which is closed in one end thereof by a bottom wall and presents a core extending from said bottom wall, leaving a space between the core and an inner periphery of a lateral wall thereof.

According to one embodiment, the metallic cladding material with which said space is filled is a metallic powder. The use of powder makes it possible to fill also spaces of more complicated shape, and to use different powders for different parts of said space. After filling of the hollow body with powder, the latter is closed, but not sealed.

Preferably, the powder that has been introduced into the space is pre-pressed, preferably by means of a mechanically applied force, before the hollow body is closed and evacuated from air. The pre-pressed powder preferably fills the hollow body up to the upper end thereof, i.e. the end thereof at which an upper wall (hat), is attached in connection to the closure of the hollow body. The hollow body is closed such that there is communication between the inner space filled with powder and the surrounding. In other words, the hollow body is not sealed.

According to an alternative embodiment, the metallic cladding material with which said space is filled is a solid body that has a shape and size corresponding to the shape and size of said space. Thereby, the risk of having voids or the like that might be caused by a defect powder or due inexact filling of said space or erroneous pressing of the powder, is avoided, as well as the measures that have to be taken when handling a powder. An upper wall is not necessitated for the closure of the hollow body. Closure of the hollow body is achieved as the solid body of cladding material is set in place.

According to a preferred embodiment, the metallic body produced by means of said method is a nozzle, in particular an injector nozzle for diesel engines.

### BRIEF DESCRIPTION OF THE DRAWINGS

An embodiment of the present invention will now be described more in detail with reference to the annexed drawing, on which

FIG. 1 is a cross section of a blank, outgoing from which a metallic body provided with a metallic cladding is to be produced,

FIGS. 2-7 are cross sections showing essential steps of the method according to the present invention,

FIG. 8 is a side view showing a semi-product obtained as a result of the steps disclosed in FIGS. 1-7,

FIG. 9 is a cross section of a final body obtained from the semi product shown in FIG. 8,

FIGS. 10 and 11 are cross sections showing how the final body shown in FIG. 9 is machined to a final shape, and

FIG. 12 is a perspective view of the body shown in FIG. 11.

### DETAILED DESCRIPTION OF THE INVENTION

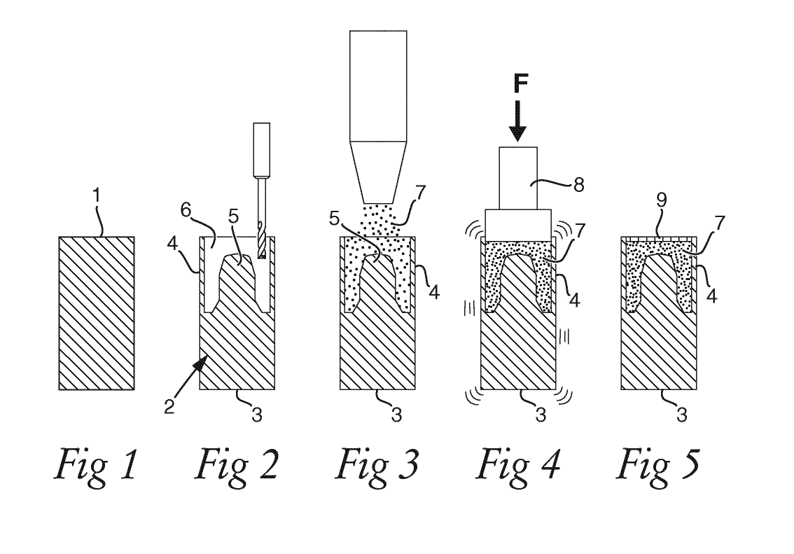

FIGS. 1-7 show essential steps of the method of the present invention for the production of an injection nozzle for a diesel engine. FIG. 1 shows a blank 1, here formed by a piece of bar 1, from which a hollow body 2 as shown in FIG. 2 is formed by means of any suitable machining operation, preferably by means of a turning operation. The bar 1 has a circular cross section in a plane perpendicular to its longitudinal axis. Alternatively, the hollow body 2 shown in FIG. 2 could be formed by attaching a tube (with or without a bottom wall) onto a core part. For the purpose of forming an injection nozzle for a diesel engine, the blank 1 may preferably be constituted by any suitable steel, preferably tool steel. For other applications, the blank may be constituted by other metallic alloys with compositions different from those of steel. It is also conceivable that the blank consists of portions of different compositions.

The hollow body 2 comprises a first part formed by a bottom wall 3 and a lateral wall 4. It also comprises a second part formed by a core 5 that extends from the bottom wall 3 of the hollow body 2, wherein there is a space 6 (formed by a circumferential spacing) between the lateral outer periphery of said core 5 and the inner periphery of the lateral wall 4 of the hollow body 2. The lateral wall 4 extends beyond the core 5 in the longitudinal direction of the latter. In the preferred embodiment described here, the bottom wall 3, the lateral wall 4 and the core 5 are thus all formed by one and the same piece of material. Thereby, the positions of the respective parts in relation to each other can be very precise, and there is no need of any welding operation or the like in order to attach one part to the other.

FIG. 3 shows a further step of the method of the present invention, during which a metallic cladding material 7, that later will form a cladding on said core 5, is introduced into said space 6. In the preferred embodiment shown here, the cladding material 7 is in the form of a powder. However, it might be conceived to fill said space 6 with a solid piece of cladding material, provided that the space 6 has a shape that enables introduction of a solid piece of material of corresponding shape into the latter. The cladding material 7, here formed by a powder, also covers an upper surface of the core 5, such that, upon subsequent attachment of the cladding material 7 to the core 5, the top of the latter is fully covered by the cladding material 7.

The cladding material 7 has a different microstructure and/or composition than the part of the hollow body 2 on which it is to form a cladding. In this specific case, the part on which the cladding material is to form a cladding is the core 5. However, it is also conceivable that, in a different application, the cladding material could be provided for the purpose of forming a cladding on the inside of, for example, the lateral wall of a hollow body. In the present embodiment (injection nozzle for a diesel engine), the cladding material 7 has a different composition than the hollow body 2. Preferably the cladding material 7 comprises a metallic alloy that results in an improved corrosion resistance of the final product at the region or regions in which it forms a cladding on said part, here the core 5, of the hollow body 2. Preferably, when the final product is to be an injection nozzle for a diesel engine, the cladding material consists of a Nickel-based material, preferably any of NiCr49Nb1, NiCr22Al6, or NiCr22Mo8Nb4Ti.

Subsequent to the filling of the space 6 with the cladding material 7, the latter is subjected to a compression step, in which a unidirectional compressive mechanical force F is applied to the cladding material 7. In FIG. 4, such a compression is represented by a stamping element 8 provided to apply said force F onto the powder of the cladding material 7 from an open end of the hollow body 2. The compression of the powder of the cladding material 7 could also at least to some extent be achieved by means of shaking of the hollow body 2, as also indicated in FIG. 4. In the case when the cladding material 7 is formed by a solid piece of material, this compression step will not be necessary.

When a compressed and relatively dense cladding material 7 is provided inside the hollow body 2, the latter is closed. FIG. 5 illustrates how such closure is achieved by means of provision of an upper wall element 9 that is attached to an upper end of the lateral wall 4 of the hollow body 2, thereby forming an upper wall 9. There is no sealing provided between the upper wall element 9 and the lateral wall 4 of the hollow body 2. Accordingly, there is a communication between the inner space of the hollow body and the surrounding atmosphere. Closure of the hollow body 2 is preferred when the cladding material 7 previously filled into the latter is on a powder state. If the cladding material is in a solid state, closure with a dedicated upper wall is not necessitated, but is achieved as the cladding material itself is set in place in the hollow body 2.

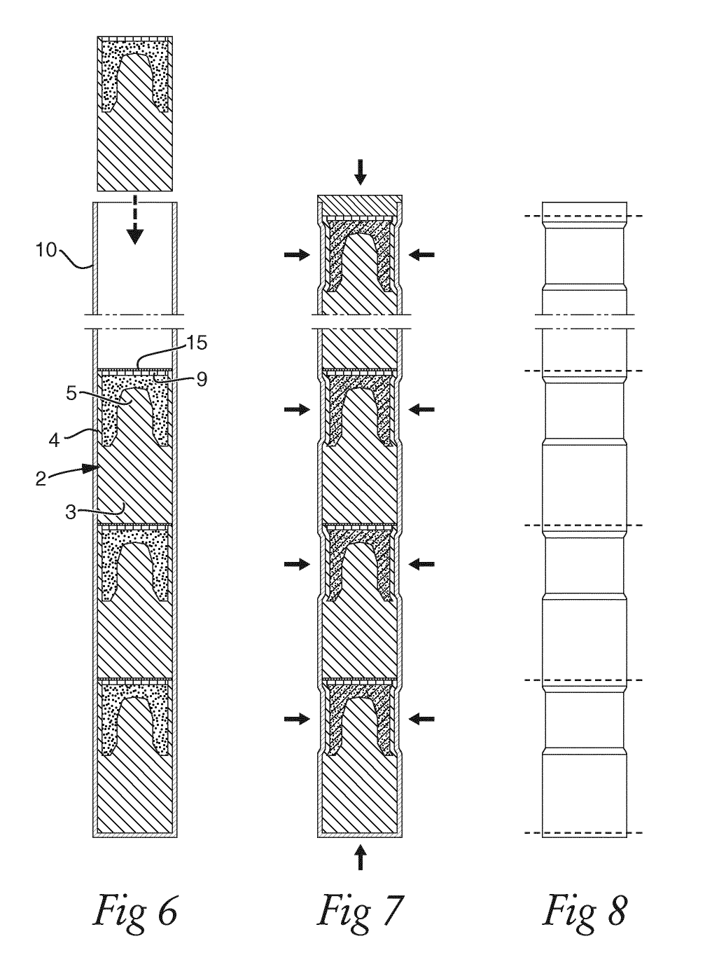

According to the invention, and as shown in FIG. 6, there is provided a capsule 10 into which a plurality of thus formed hollow bodies 2, filled with said cladding material 7, are to be placed before a subsequent Hot Isostatic Pressing thereof is to be performed. The capsule 10 is provided for the purpose of enabling an evacuation of air from the plurality of hollow bodies, thereby making it possible to avoid the step of evacuating air from each of the latter and the step of sealing each of the latter. The capsule 10 is made of any suitable metal alloy. It is tubular. It has a wall thickness that is large enough (normally at least 1 mm) to guarantee the sealing of the interior thereof also under the HIP conditions that it will be subjected to. It has a wall thickness small enough to permit deformation thereof, for example as a result of deformation of the hollow bodies 2 during the HIP process. The capsule 10 is formed by a tube that is coaxial with the hollow body 2 (when the latter is placed inside the capsule 10) and has a lateral inner periphery that has a shape and dimension that corresponds to the shape and dimension of the outer lateral periphery of said hollow body 2. The capsule 10 has a length which is somewhat larger than an integer of the length of an individual hollow body 2 (when the latter is in its final shape and ready for insertion into the capsule 10. The plurality of hollow bodies 2 are stapled on each other inside the capsule, such that the central axis of said bodies 2 and the capsule 10 coincide. Between each pair of hollow bodies 2 there is provided a thin disc or layer 15 of a dividing material, preferably formed by a heat resistant fibre-based material, for the purpose of preventing the individual hollow bodies from getting directly bonded to each other during the HIP process, and thereby to facilitate the subsequent separation of the hollow bodies 2 from each other.

When the hollow body 2 is inserted into the capsule 10, the spacing between the outer periphery thereof and the inner periphery of the capsule 10 is only large enough to enable said insertion. Too large a difference between the diameter of the hollow body 2 and the inner diameter of the capsule 10 will result in less uniform compression transferred to the hollow body through the capsule during subsequent HIP. Preferably, the ratio between an inner diameter of the capsule 10 and an outer diameter of said hollow body 2, defined as D_{capsule}/D_{hollow body} is in the range of 1-1,10.

The wall thickness of the capsule 10 as well as the wall thickness of the lateral wall 4 of the hollow body 2 is small enough to permit deformation thereof caused by the isostatic pressure that said walls are subjected to during the following HIP process. Subsequent to the positioning of the hollow bodies 2 in the capsule 10, the latter is closed in its opposite ends, as indicated in FIG. 7. Thereafter, the whole unit comprised by the capsule 10 and the hollow bodies 2 provided therein, is subjected to an isostatic pressure generated by means of gas and an elevated temperature (also indicated in FIG. 7). Typically, the pressure is in the range of 700-1100 bar, preferably, 900-1100 bar, and most preferably around 1000 bar, and the temperature is chosen such that that the densification of the cladding material 7 and the bonding thereof to the hollow body 2 is achieved in accordance with the principles of HIP, without any upcoming of melt phases in the materials involved. Preferably, and in particular for a system in which the hollow body 2 is made of a tool steel and the cladding material 7 is a Ni-based material, the temperature is in the range of 900-1200° C., preferably 1100-1200° C., and most preferably around 1150° C., and the duration of the HIP-step, once said pressure and temperature has been reached, is in the range of 1-4 hours, preferably around 3 hours. After the HIP process has been completed, said unit may preferably be subjected to any suitable heat treatment, such as annealing. In the preferred embodiment described herein, said unit is subjected to annealing, preferably at a temperature of approximately 650° C. for a period of approximately 6 hours.

As a result of the HIP process the cladding material is densified (when the initial material is in the state of a powder) and bonded to the lateral wall 3, the upper wall 9 and the core 5 of the hollow body 2. Due to the densification of the cladding material and a corresponding deformation of the lateral wall 4 of the hollow bodies 2 and the capsule 10, the latter will present waists at locations corresponding to where the cladding material is present in the capsule. This can be more clearly seen in FIG. 7 and FIG. 8, which is a side view of the capsule 10 after HIP thereof. Accordingly, the method according to the invention, when an initial cladding material in powder state is being used, results in a capsule shape that enables an observer to identify, by ocular inspection, exactly where the individual hollow bodies 2 are located in the capsule 10. Thereby, separation of the individual hollow bodies 2 from each other by way of cutting off the capsule 10 is facilitated. Since the discs 15 are arranged between the individual hollow bodies 2, there is no direct metallic interconnection or bond between neighbouring hollow bodies 2, and since said discs are easily detached from the respective hollow body 2, cutting of the capsule 10 is actually the only metal-cutting operation required in order to separate said bodies 2 from each other. Cutting is thereby performed along the hatched lines indicated in FIG. 8.

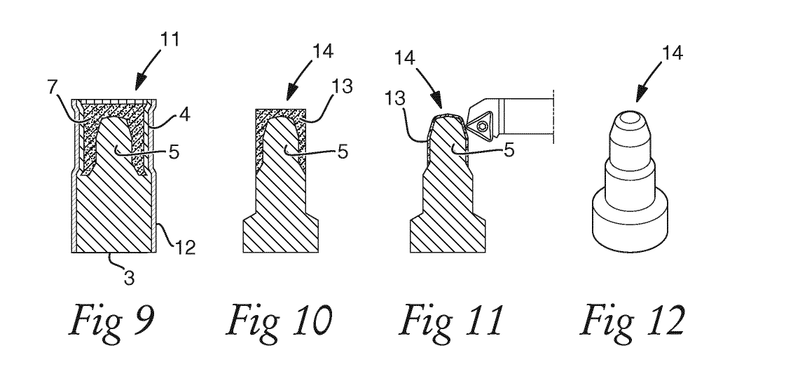

After separation of the individual hollow bodies 2 from each other final bodies 11 with the shape shown in FIG. 9 are obtained. As can be seen, these final bodies 11 also comprise an outer lateral wall 12 formed by the remaining part of the capsule 10 that has become bonded to the outer periphery of the lateral wall 4 of the tubular part 2 during the HIP process. The final bodies 11 are subjected to a machining operation, as indicated in FIGS. 10 and 11, during which a part of the final body 11 is removed such that the cladding material 7 is exposed as a cladding 13. In the present case of an injection nozzle for a diesel engine, the outer lateral wall 12 formed by the remaining part of the capsule 10, and the upper wall 9 and the lateral wall 4 of the hollow body 2, and a part of the cladding material 7 are removed by way of machining such that only the core 5, covered partly by a cladding 13 formed by a remaining part of the cladding material 7 remains. The machining is a turning operation. The turning operation is performed by setting up the final body 11 in a lathe and rotating it around its central axis, whereby it is presumed that the final body is symmetric around its central axis. Thanks to the proposed measures taken before this step, the final body is in fact very symmetric, and therefore the thickness of the remaining cladding 13 can be very exactly determined on basis of the known diameter of the core 5. The remaining body is shown in FIG. 11 and denoted 14 therein. This body 14 may be referred to as an injector nozzle for a diesel engine, provided with a metallic cladding 13 thereon. In order to finalize the production of the nozzle, through holes (not shown) are to be bored in the latter in order to enable its function as a nozzle. Possible other measures, such as providing the nozzle with engagement means in order to enable engagement thereof with other components in the fuel supply system of a diesel engine, is off course also conceivable but however not crucial to the inventive idea as presented above. FIG. 12 is merely a perspective view, showing the overall geometry of the remaining body 14, in particular indicating the circularity of the cross sections thereof taken through planes perpendicular to the longitudinal axis thereof.

1. A method of producing a metallic body (14) provided with a metallic cladding (13), comprising the following steps:
providing a hollow body including a bottom wall, a core extending from the bottom wall, and a lateral wall that presents an inner space;
filling said space with a metallic cladding material that will form said cladding;
positioning the hollow body in a metallic capsule;
closing the metallic capsule and evacuating air from the interior of the latter; and
applying an elevated pressure and an elevated temperature on the outside of said capsule such that said cladding material is bonded to said hollow body, wherein said capsule is coaxial with the hollow body and has a lateral inner periphery that has a shape and dimension that corresponds to the shape and dimension of an outer lateral periphery of said hollow body, said hollow body with the core therein being formed in a machining operation in which material is removed from a blank of a solid piece of metal material, wherein after said application of elevated pressure and elevated temperature, a final body, formed by the hollow body and the cladding material, is subjected to a machining operation, in which one first part of the hollow body is removed and the cladding material is exposed as a cladding on a second part of the hollow body, wherein said first part includes the lateral wall of the hollow body and that said second part of the hollow body includes the core that extends from the bottom wall of the hollow body.

2. A method according to claim 1, a ratio between an inner diameter of the capsule and an outer diameter of said hollow body, defined as Dcapsule/Dhollow body is in the range of 1-1.15.

3. A method according to claim 1, wherein the capsule is elongated and has a length which is a plurality of the length of the hollow body, and that a plurality of hollow bodies are stapled on each other inside the capsule before the latter is closed.

4. A method according to claim 1, wherein the metallic cladding material with which said space is filled is a metallic powder.

5. A method according to claim 4, wherein said metallic powder is pre-pressed before the hollow body is closed.

6. A method according to claim 1, wherein the metallic cladding material with which said space is filled is a solid body that has a shape and size corresponding to the shape and size of said space.

7. A method according to claim 1, wherein the metallic body produced by means of said method is a nozzle.

8. A method according to claim 7, wherein said nozzle is an injector nozzle for diesel engines.
